(19) United States
(12) Patent Application Publication
(10) Pub. No.: US 2006/0200654 A1
(43) Pub. Date: Sep. 7, 2006

(54) Stop waiting for source operand when conditional instruction will not execute

(76) Inventors: James Norris Dieffenderfer, Apex, NC (US); Jeffrey Todd Bridges, Raleigh, NC (US); Michael Scott McIlvaine, Raleigh, NC (US); Thomas Andrew Sartorius, Raleigh, NC (US)

Correspondence Address: QUALCOMM INCORPORATED, 5775 MOREHOUSE DR., SAN DIEGO, CA, 92121, US

(21) Appl. No.: 11/073,165

(22) Filed: Mar. 4, 2005

(51) Int. Cl. G06F 9/44

(52) U.S. Cl. 712/226

(57) ABSTRACT

The delay of non-executing conditional instructions, that would otherwise be imposed while waiting for late operand data, is alleviated based on an early recognition that such instructions will not execute on the current pass through a pipeline processor. At an appropriate point prior to execution, a determination regarding the condition is made. If the condition is such that the instruction will not execute on this pass through the pipeline, the hold with regard to the conditional instruction may be terminated, that is to say skipped or stopped prior to completion of receiving all the associated operand data. Flow of the non-executing instruction through the pipeline, for example, need not wait for an earlier instruction to compute and write source operand data for use by the conditional instruction.

### TECHNICAL FIELD

The present teachings relate to techniques for avoiding delays waiting for operand data for a conditional instruction where a condition is such that the instruction will not execute, and to pipelined processors implementing such techniques.

### BACKGROUND

Modern microprocessors and other programmable processor circuits often rely on a pipelined processing architecture, to improve execution speed. A pipelined processor includes multiple processing stages for sequentially processing each instruction as it moves through the pipeline. While one stage is processing an instruction, other stages along the pipeline are concurrently processing other instructions.

Each stage of a pipeline performs a different function necessary in the overall processing of each program instruction. Although the order and/or functions may vary slightly, a typical simple pipeline includes an instruction Fetch stage, an instruction Decode stage, a register file access or Reg-read stage, an Execute stage and a result Write-back stage. More advanced processor designs break some or all of these stages down into several separate stages for performing sub-portions of these functions. Super scalar designs break the functions down further and/or provide duplicate functions or delegate specific functions to specific pipelines, to concurrently perform operations in parallel pipelines. As processor speeds increase, a given stage has less time to perform its function. To maintain or further improve performance, each stage is sub-divided. Each new stage performs less work during a given cycle, but there are more stages operating concurrently at the higher clock rate.

In higher speed architectures, obtaining data necessary for an instruction to operate on, that is to say the corresponding operand data, requires more time relative to the processor cycle time and may result in one or more cycles of delay. Further, it often occurs that one instruction must obtain operand data after an earlier or older instruction has written that operand data, typically, to a designated register. A read after write hazard occurs when the instruction writing the operand data takes a number of processing cycles (e.g. for a multiply operation), and the later instruction looking to use that operand data must wait until the older instruction has computed and completed writing the necessary operand data. There is a true data dependency in that the later instruction needs the data from the earlier instruction in order to complete its operation. As a result, the processing for the later instruction stalls, either in the register read stage or at the start of the execution stage.

The impact of this read after write (RAW) hazard increases as the latency of the older instruction that is writing the operand increases, since the stalling delays more and more processing cycles. If the pipeline has only one execution stage, the hazard would really be no problem, as the later instruction would always wait for the older instruction to finish execution anyway. However, as the pipeline deepens to include multiple execution stages or parallel execution stages in a super-scalar architecture, the later instruction could proceed through one or more stages while the older instruction is executing ahead of it, but the staging of the later instruction must wait (stall) for the operand data result from the earlier instruction.

There typically is no wait for data, if operand data is obtained from the register file. However, there is a wait for data from the register file if the instruction must stall in the register file read stage (or earlier) and wait for long latency operand data to write the register file. In this case the waiting instruction reads (or re-reads) the register file to obtain its data. This method is only used if there is little or no operand data forwarding paths from other result producing stages. Virtually all modern processors have operand forwarding networks and do not need to read RAW operands from the register file.)

A conditional execution instruction is one that either executes or does not, based on the status of some identified condition, usually a condition indicated by one or more bits in condition register. A conditional instruction leads to performance of its specified function in the event one or more condition codes in a condition code (CC) register match the condition(s) specified in the instruction. If the condition is not met, the conditional instruction will not be executed. In that event, the instruction may be marked as a ‘NOP’ instruction that passes through the further stages of pipeline without execution, or the conditional execution instruction may be removed from the stream of instructions in the pipeline. Commonly, the conditional analysis is performed as part of the execution processing.

Most conditional instructions, for example conditional adds, subtractions, multiplies, divides and the like, require operand data for performance of the specified functions when the respective conditions are met. If a conditional instruction will execute (condition met), then the further processing thereof must wait for the necessary operand data to be obtained from a register file, or via a result forwarding network from the pipeline itself, or from memory. Existing systems impose this same wait, stalling processing of the conditional instruction through the pipeline, regardless of whether or not the condition is met.

Where a later instruction needs operand data but is conditional, if the condition is not met, the result would not be executed. In that case, the wait for readout of the operand data imposes an unnecessary delay.

### SUMMARY

The teachings herein alleviate the delay for non-executing conditional instructions, that would otherwise be imposed while waiting for RAW hazard operand data. At an appropriate point prior to execution, a determination regarding the condition is made. If the condition is such that the instruction will not execute on this pass through the pipeline, the hold with regard to the conditional instruction may be terminated, that is to say skipped or stopped prior to completion of receiving all of the associated operand data.

The scope of such teachings encompass, for example, a method of controlling processing of a conditional instruction through a pipeline processor comprising a number of processing stages. The method involves decoding a conditional instruction in a first stage of the pipeline and analyzing a condition required for executing the instruction to determine whether or not the instruction should be executed by a later stage of the pipeline. If the analysis of the condition indicates that the instruction should not be executed, the stall for any operand data that has not yet been received that otherwise would have been needed for execution of the conditional instruction may be shortened or skipped.

The non-executing conditional instruction need not wait to receive all of its operand data. For example, there is no longer a delay until an earlier instruction computes and writes the operand data for the conditional instruction.

Typically, the instruction would not execute if specified conditions of the conditional instruction are not met. However, there may be cases where the conditional instruction is structured so as not to execute if the specified condition is met.

There are several processing techniques that would allow the instruction to proceed through the pipeline without execution on the instruction. For example, the instruction could be marked as or converted to a no-operation (NOP) instruction. Later stages would recognize the NOP and would not execute the original instruction (note the NOP is executed as a NOP). Alternatively, the instruction could be marked as if all operand data had been received to circumvent waiting for long latency data. In this later case, when the Execute stage processes the instruction, it would determine again that conditions were such that the instruction should not be executed and act accordingly.

Other approaches might remove the non-executing conditional instruction from the pipeline entirely, in response to the first determination that the instruction will not be executed due to the applicable condition state. The conditional instruction could be effectively removed by allowing the next instruction in line to over-write it in the stage that determined the instruction would not execute, or the processor might clock in a clear state in the stage currently holding the conditional instruction.

Cases occur where the condition specified by the conditional instruction may not be set. As an earlier instruction may write necessary operand data, an earlier instruction also may set a code or data specifying status of a particular condition. Before a determination can be made as to whether or not the condition will lead to execution of the conditional instruction, it may be necessary to look ahead of the conditional instruction in the pipeline to determine if any earlier instruction that is still in process may possibly set the data regarding the relevant condition. If there is no such possibility of an earlier instruction setting the relevant condition data, then the condition analysis can determine if the conditional instruction will or will not execute, and then wait or not for the operand data needed for execution of that instruction. If there is an earlier instruction that will set the relevant condition data, then the conditional instruction must wait for the update of condition data to be known before the conditional instruction can determine if will execute or not.

The present teachings also encompass pipelined processors. For example, such a processor might include a decode stage, a register read stage and an execution section. The execution section comprises multiple stages. Execution of one of the instructions is conditional, in that the one instruction is to be executed upon occurrence of a specified condition. Typically, when an instruction encounters a RAW hazard that it cannot immediately resolve with a data forwarding network, it is held, preventing it from executing until it has obtained all the source operand data needed for its execution. However, the hold before execution of the conditional instruction is stopped based upon determination that the specified condition has not occurred.

Additional objects, advantages and novel features will be set forth in part in the description which follows, and in part will become apparent to those skilled in the art upon examination of the following and the accompanying drawings or may be learned by production or operation of the examples. The objects and advantages of the present teachings may be realized and attained by practice or use of the methodologies, instrumentalities and combinations particularly pointed out in the appended claims.

### BRIEF DESCRIPTION OF THE DRAWINGS

The drawing figures depict one or more implementations in accord with the present teachings, by way of example only, not by way of limitation. In the figures, like reference numerals refer to the same or similar elements.

FIG. 1 is a functional block diagram of a simplified example of a pipelined processor, which may implement the conditional instruction processing in accord with the techniques discussed herein.

FIG. 2 is a graphical representation of the format of a conditional instruction, in accord with the ARM protocol.

FIG. 3 is a graphical representation of the format of a condition statement and an associated executable instruction, together forming a conditional instruction in accord with the THUMB extension of the ARM protocol.

FIG. 4 is a flow diagram, useful in explaining an example of the logic that may be applied to process a conditional instruction.

### DETAILED DESCRIPTION

In the following detailed description, numerous specific details are set forth by way of examples in order to provide a thorough understanding of the relevant teachings. However, it should be apparent to those skilled in the art that the present teachings may be practiced without such details. In other instances, well known methods, procedures, components, and circuitry have been described at a relatively high-level, without detail, in order to avoid unnecessarily obscuring aspects of the present teachings.

The various techniques disclosed herein relate to withdrawing or avoiding stalling of a conditional instruction in a pipeline, to await receipt of operand data for non-executing conditional instructions. For example, such techniques reduce or eliminate the wait for writing of operand data by an earlier instruction that is in-flight through the pipeline, for a conditional instruction that will not execute on this pass through the pipeline.

Execution of a conditional instruction, that is to say performance of the processing specified by the instruction, is dependent on a specified condition, such as may be represented by one or more bits set in the condition code (CC) register. There may be cases where the conditional instruction is structured so as not to execute if the specified conditions are met. However, for purposes of further discussion of the examples, a conditional instruction executes if the condition(s) are met and does not execute if specified condition(s) of the conditional instruction is not met.

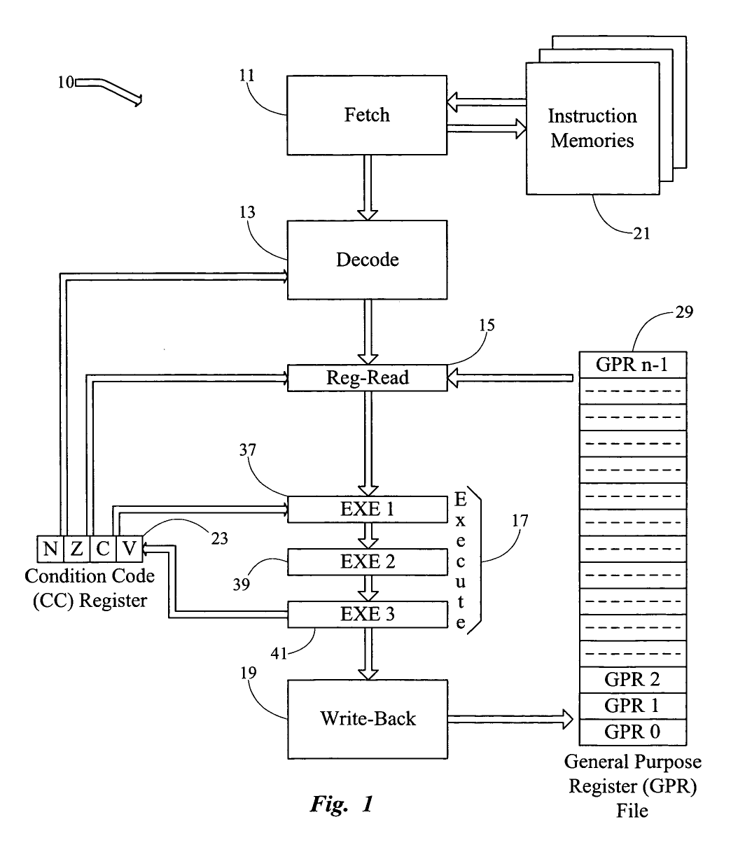

Reference now is made in detail to the examples illustrated in the accompanying drawings and discussed below. FIG. 1 is a simplified block diagram of a pipelined processor 10. For ease of discussion, the example of a pipeline 10 is a scalar design, essentially implementing a single pipe. Those skilled in the art will understand, however, that the processing of conditional instructions discussed herein also is applicable to super scalar designs and other architectures implementing parallel pipelines. Also, the depth of the pipeline (e.g. number of stages) is representative only. An actual pipeline may have fewer stages or more stages than the pipeline 10 in the example. An actual super scalar example may consist of two or more parallel pipelines.

The simplified pipeline 10 includes five major categories of pipelined processing stages, Fetch 11 Decode 13, Reg-read 15, Execute 17 and Write-back 19. The arrows in the diagram represent logical data flows, not necessarily physical connections. Those skilled in the art will recognize that any of these stages may be broken down into multiple stages performing portions of the relevant function, or that the pipeline may include additional stages for providing additional functionality. For discussion purposes, several of the major categories of stages are shown as single stages, although typically each is broken down into two or more stages for high speed processors. Where helpful to discussion of the processing regarding conditional instructions and avoiding the wait time for writing of necessary source operand data for such instructions, the execution section is shown as comprising multiple stages.

In the exemplary pipeline 10, the first stage is an instruction Fetch stage 11. The Fetch stage 11 obtains instructions for processing by later stages. The Fetch stage 11 obtains the instructions from a hierarchy of memories represented generically by the memories 21. The memories 21 typically include an instruction or level 1 (L1) cache, a level 2 (L2) cache and main memory. Instructions may be loaded to main memory from other sources, e.g. a boot ROM or disk drive. The Fetch stage 11 supplies each instruction to a Decode stage 13. Logic of the instruction Decode stage 13 decodes the instruction bytes received and supplies the result to the next stage of the pipeline.

Conditional processing may begin as early as the Decode stage 13, in the example 10. Conditional processing entails analysis of data indicating one or more condition states, to determine whether or not a condition controlling processing of an instruction requires execution of the conditional instruction. The example uses condition codes as the condition data. Condition codes typically are bits set in a condition register. For example, ARM notation refers to a condition code (CC) register 23, which typically includes NZCV condition bits. The Negative (N) bit indicates if the last prior recorded (note that not all results are recorded) result is negative or not. The Zero (Z) bit indicates whether or not the result was all zeroes. The Carry (C) bit indicates if the last result involved a carry-out. The Overflow (V) bit indicates whether or not the result was an overflow. As discussed later, as part of its processing, the logic of the Decode stage 13 will determine whether or not each instruction is a conditional instruction. If conditional, the Decode stage may check the status of bits in the CC register 23 that indicate various conditions, as a first determination of whether or not the conditional instruction will execute on this pass through the pipeline of processor 10.

The next stage provides local register access or Reg-read, as represented by stage 15. Logic of the Reg-read stage 15 accesses operand data in specified registers in a general purpose register (GPR) file 29. There are n GPR registers in the file 29, numbered 0 to n-1. In some cases, the logic of the Reg-read stage 15 may obtain operand data from memory or other resources (not shown). As discussed in more detail, later, for conditional instructions, the logic of the Reg-read stage 15 also checks the status of bits in the register 23 that indicate various conditions, to determine whether or not a conditional instruction will execute.

The Reg-read stage 15 passes the instruction and necessary operand data to the group of stages 17 providing the Execute function. The group of Execute stages 17 essentially execute the particular function of each instruction on the retrieved operand data and produce a result. The stage or stages providing the Execute function may, for example, implement an arithmetic logic unit (ALU). In the example, the Execute section 17 of the pipeline comprises multiple stages. Although the number of such stages may differ, three are shown for purposes of this example, referred to generally as the Exe 1 stage 37, the Exe 2 stage 39 and the Exe 3 stage 41.

The last stage of the Execute section 17, in this case the Exe 3 stage 41 supplies the result or results of execution of each instruction to the Write-back stage 19. Of course, there may be ‘early-out’ paths from Exe stages 37 and 39 to the Write-back stage 19 as well. Also, there will typically be a result forwarding network, to forward results to later instructions passing through the pipeline. The stage 19 writes the results back to a register in the file 29 or to memory (not shown). Data written to a GPR register by one instruction may be read as operand data and processed in accord with a later instruction flowing through the pipeline of the processor 10.

Although not shown separately, each stage of the pipeline 10 typically comprises a state machine or the like implementing the relevant logic functions and an associated register for passing the instruction and/or any processing results to the next stage or back to the GPR register file 29.

Most instructions processed through the pipeline 10 will require operand data, to be processed during execution of the instructions. Often, such an instruction involves waiting for operand data at stage the EXE 1 stage 37 or an earlier stage, when an earlier or older instruction has executed through one or more of the stages 37, 39 and 41 but has not written the GPR file 29 or placed its result on the forwarding network in time for the dependent instruction to receive it without stalling. This data dependency creates a read after write (RAW) hazard.

Sometimes, an earlier instruction writing the operand data takes a number processing cycles to complete its computation and write-back the result. A multiply instruction, for example, may require several processing cycles to complete the multiplication. During these cycles, a later instruction requiring the operand data, e.g. the result of the multiplication, must wait until the older instruction has computed and completed writing the necessary operand data. As another example, execution of an earlier instruction may result in initiation of an operation to load data into a specified register. However, if there is a data miss (the data to be loaded is not in cache), then the loading is queued to read the data from some other resource. Although execution of the instruction that called for the loading may be complete, the actual loading operation may take a number of additional cycles before the necessary data is loaded into the register and becomes available as operand data for use by the later instruction.

As a result of the time needed for the necessary operand data to become available in such situations, the processing for the later instruction that needs the operand data stalls. The stall for the necessary operand data could be in the Decode stage. Typically, the processor 10 imposes this stall in one of the Reg-read stage 15 or at the start of the first execution stage (EXE 1) 37. In the example, the stall to await operand data holds each instruction at the EXE 1 stage 37, including any conditional instruction needing operand data.

As taught herein, a conditional instruction will skip the stall at stage 37 or will result in early termination of the stall, if the condition specified in or for that instruction is not met. If a condition is met or if the instruction is not conditional, the instruction will await receipt of the necessary operand data, in the normal manner.

In the normal processing of a conditional instruction, one of the execution stages, such as the EXE 1 stage 37 will check the condition while processing the conditional instruction, as represented by the arrow from the register 23 to the stage 37. Subsequent processing in the stages 37-41 will or will not serve to execute the function of the instruction on any operand data based on the comparison of the condition code CC in the register 23 to the condition specified in the instruction.

In addition, one or more of the earlier stages of the pipeline will check the condition in a similar manner, as the conditional instruction passes down the pipeline 10. In the example, an initial check may be made during processing in the Decode stage 13, as represented by the arrow from the register 23 to the Decode stage 13. The Reg-read stage 15 may also check the condition register 23 to determine if the condition is met, while the stage is processing the conditional instruction, as represented by the arrow from the register 23 to the stage 15. If any of these earlier checks determine that the condition will not be met, for the particular pass of the conditional instruction through the pipeline 10, processing will terminate or skip any waiting at the EXE 1 stage 37 for completion of receiving the operand data that otherwise would have been required for execution of the conditional instruction, but had not yet been received.

Processing of a conditional instruction therefore entails determining that the instruction is conditional and examining condition codes or bits indicating condition status, to determine if the specified condition is met. An instruction may have a field within itself that indicates that it is conditional or an instruction's conditionality may be imposed on it by another instruction or mechanism. The teachings are applicable to a variety of software or instruction formats. However, it may be helpful to briefly summarize some examples.

Some processor architectures, such as ‘ARM’ type processors licensed by Advanced Risc Machines Limited, support conditional instructions. The ARM instruction set has a field that is part of the instruction itself that determines whether that instruction is conditional or unconditional. Advance Risc Machines Limited also offers the THUMB-2 instruction set. In this latter instruction set, the conditionality of an instruction may be imposed upon it by an earlier instruction. The THUMB-2 instruction set has a condition imposing instruction called IT (for If Then). The THUMB-2 instruction set has both 16 and 32 bit instruction lengths. The IT instruction itself is only 16 bits. In addition, IT instructions can affect up to the next four instructions, each of which may be 16 or 32 bits.

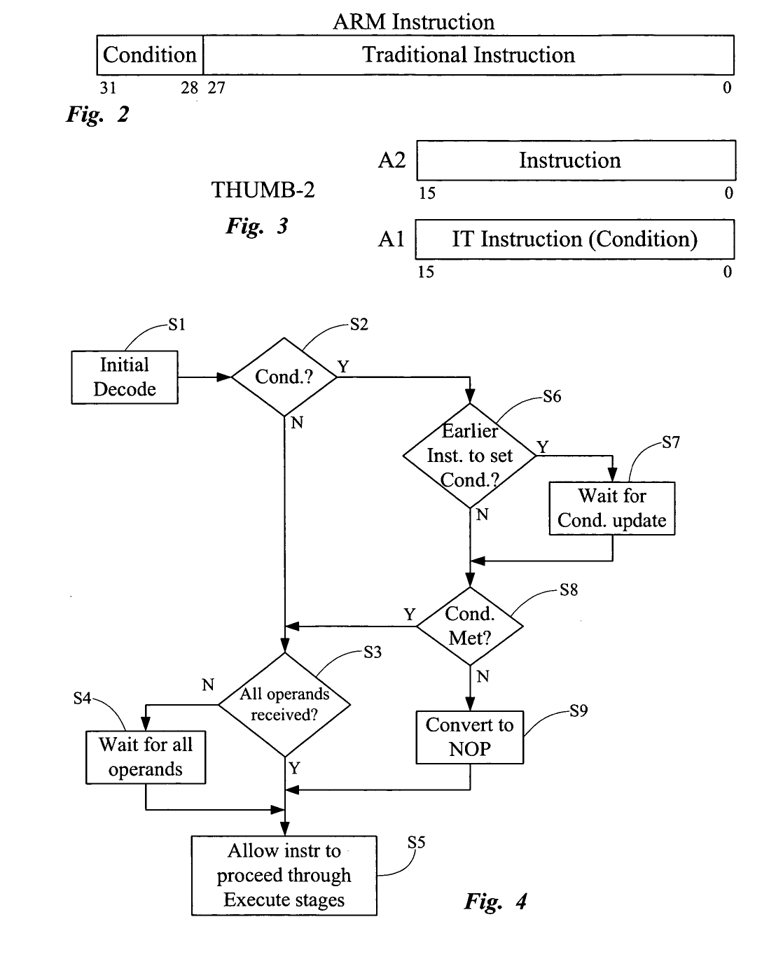

FIG. 2 illustrates the format of a conditional instruction, in the normal ARM format. The instruction is 32-bits long, numbered from bit 31 down bit 0 in the illustrated notation. The ARM conditional instruction includes a 4-bit condition field (bits 31-28), and 28-bits for a traditional instruction (bits 27-0). The condition field contains a condition code that essentially specifies whether the instruction is conditional, which code bits to consider to determine if the condition is met and possibly how that condition is met. The remaining 28-bits contain the instruction that is to be performed if the condition is met. With reference to FIG. 3, in THUMB-2 mode, a “conditional” instruction may comprise at least two instructions A1 and A2. A first instruction A1 is an IT type instruction that provides the condition statement and indicates that the next instruction (or next several instructions) A2 is to be performed if the condition of the first instruction A1 is met. As such, execution of the second instruction A2 is made a conditional instruction as imposed on it by the first instruction A1. Although A2 is shown as a second 16-bit instructions, as noted above, each of the subsequent instructions made conditional by the IT instruction A1 (up to four subsequent instructions in the current version of THUMB-2) may 16 or 32 bits long.

In either case, the instruction is not executed if the condition is not met, meaning that no architecturally visible results are produced if the condition is not met. In each case, logic in one or more of the stages of the pipeline 10 recognizes the conditional instruction from the code in the condition field and determines if the bits in the condition code (CC) register 23 satisfy the specified condition. Typically, the determination of whether or not the condition is met was performed only after all operand data was retrieved.

It should be noted, however, that there will be cases in which the condition data in the CC register 23 also must be set by an earlier instruction, in order to determine whether or not the condition is met for the particular conditional instruction. The logic of one or more of the stages, e.g. Decode stage 13, Reg-read stage 15, or EXE 1 stage 37, looks down the pipeline to see if any earlier instructions need to execute to set the relevant bit(s) in the condition code (CC) register 23 for condition determination with respect to the current conditional instruction. If (or when) there is no earlier instruction that remains to be executed that will set the particular bit(s) in the condition code (CC) register 23, the logic of the earlier stage can determine if the condition will be met or not on this pass of the conditional instruction through the pipeline of the processor 10. At this time, it can be determined from the condition, whether or not the instruction will execute on this pass. If not, there will be no execution, and there is no need to wait for operand data.

The look ahead for earlier instruction(s) that could set the relevant condition data may be implemented in a variety of ways. An optimal solution for tracking instructions and states is chosen for the particular pipeline architecture and often is analogous to schemes used to check for earlier instruction that may still write or load necessary operand data. However, it may be helpful to summarize a few examples of the look ahead regarding setting of conditional data.

A simple in-order execution pipeline, such as the example shown, executes each instruction in sequence as the instructions flow through the pipeline. In such a pipeline, each of the execution stages would include a control bit indicating whether the instruction currently in the stage will set the condition code as part of its execution. The stage processing the conditional instruction looks at those control bits to determine when no earlier instruction will set the condition code, to allow that stage to determine if the conditional instruction will execute. For example, the Reg-read stage 15 processing the conditional instruction might use OR logic on the control bits of the execution stages 37, 39 and 41. If all the control bits indicate no, the OR result is no, and the Reg-read stage 15 can determine that no earlier instruction in-flight through the execution stages 37, 39 and 41 will set the condition code Checking of any instruction in the Write-back stage 19 would also be included if forwarding of the condition code result is not used. Alternatively, the stage processing the conditional instruction might sequentially scan through the control bits of the stages 37, 39 and 41 executing earlier instructions until the scan can pass through all of the execution stages without hitting a control bit indicating an instruction will set the condition code.

Those skilled in the art will recognize that many other schemes may be used to look ahead to determine if an earlier instruction will set the condition code (or a relevant bit in the condition code), in ways similar to those used to look ahead to determine if relevant operand data needs to be computed and written back. More complex schemes will be needed for application in more complex processor architectures, for example, in a super-scalar design using register remapping. In the illustrated example, it was determined if an earlier instruction would set the code in the registers 23. Of course, there may be multiple condition registers, and/or an instruction may set only a sub-set of one or more bits in the register(s). The look ahead scheme may be adapted to the particular condition setting and the particular condition that must be checked, for example, to confirm that the conditional instruction analysis need not wait for any earlier instruction to set the relevant bit or bits in the appropriate condition register or in some other condition data storage location.

As outlined above, the logic determines that the conditional instruction will not execute on the current pass through the pipeline. Hence, the processor logic can take steps to skip or remove the stall that would otherwise involve waiting for one or more earlier instructions to execute to provide the operand data. For example, the instruction could be marked as or converted to a no-operation (NOP) instruction. The NOP instruction could pass out of the EXE 1 stage 37 immediately, and later stages would recognize the NOP and would not execute the original instruction. Alternatively, the instruction could be marked as if all operand data had been received and passed immediately to the Execute section. In this later case, when the Execute stage 37 processes the instruction, it would be told or determine again that the condition or conditions were such that the instruction should not be executed and act accordingly. Other approaches might remove the conditional instruction from the pipeline, in response to the first determination that the instruction will not be executed due to the applicable condition state. The conditional instruction could be effectively removed by allowing the next instruction to over-write it or to clock in a clear state in the stage currently holding the conditional instruction.

The determination of whether older instructions will set the relevant condition bits could be a bit by bit analysis, to determine if the earlier instructions will effect the bit or bits of interest in the CC register 23, for the particular conditional instruction. In an example, any instruction that will set any one bit in the condition code (CC) register 23 sets all bits in that register. It will set any bits that it changes with new condition bit data. Bits that are unchanged are rewritten with the old values. In such an example, the logic to check if earlier instructions will effect the bit(s) of interest to the conditional instruction only needs to check if any of the older instructions that are still in-flight through the pipeline of processor 10 may set the condition code (CC) register 23, without a bit by bit analysis of which bits might be set by which earlier instruction(s). In a super scalar design, it may also be necessary to determine if any in-flight instructions in a parallel pipeline may set the condition register or the bit(s) of interest in the condition register so as to effect the conditional determination vis-à-vis the instruction of interest.

If the condition code (CC) register 23 is set before the operand data comes back, then the processor 10 can terminate the stall for the conditional instruction given that the required condition is not met. In some cases, no in-flight older instruction will set the condition code (CC) register 23. In other cases, an older in-flight instruction will set the condition code (CC) register, but it will set the condition code (CC) register 23 before all of the operand data for the conditional instruction becomes available. In both cases, some or all of the time delay imposed by the stall to obtain late arriving operand data is eliminated by the early determination that the relevant condition is not met.

It may be helpful, at this point, to consider an exemplary process flow, with reference to FIG. 4. The process flow depicted in the diagram involves functions of several stages of the processing pipeline 10. The precise location for implementation of the illustrated process steps, in the logic of the stages of the pipeline 10, is a matter that should be within the skill of a person experienced in the pipelined processor art, and statements in the following discussion as to which stages implement particular steps are given by way of example only.

The illustrated processing begins with initial decoding (S1) of an instruction. As noted above, a field of an ARM instruction or an earlier instruction of two (or more) THUMB-2 instructions can identify an instruction as conditional. Hence, the decode logic can examine appropriate portions of an instruction or instructions to determine if a given instruction is a conditional instruction (step S2). If the instruction is not conditional, processing moves from S2 to S3, at which point the later stages begin accessing the appropriate resources that contain any necessary operand data. A resource that contains operand data is typically a register file. The receiving of operand data may proceed through a number of processing cycles until it is completed. Assume in the pipelined processor 10 of our earlier example, that the Exe 1 stage 37 now contains all the necessary operand data for the instruction. From there, the instruction and operand data go to the remaining Execute stages (at step S5) to complete execution, although the instruction may advance to the Execute stages earlier if the processor can forward operand data later from other stages.

In the example, there is some period of time required for obtaining operand data (S3 to S4), e.g. for receiving data from a forwarding network, where data from an earlier instruction is obtained for a RAW hazard. Similarly, some period of time may be required for reading a register file, if the register file is used to obtain RAW data because there is no forwarding network for that operand. This period, for example, may include time to allow an earlier instruction to write necessary data into a location from which it may be obtained for the instruction waiting in EXE 1 stage 37 or loading of data from a more remote resource. Similarly, some period of time may be required for reading a register file, if the register file is used to obtain RAW data because there is no forwarding network for that operand.

Return now to consideration of processing step S2, where the decode logic examined appropriate portions of the instruction to determine if it is a conditional instruction. Now assume that the current instruction is a conditional instruction. Hence, the Decode stage 13 determines that the instruction is conditional, and processing moves from step S2 to step S6. Although not separately shown, at step S6, the later stages begin accessing the appropriate resources that contain any necessary operand data; and the receiving of operand data may proceed through a number of processing cycles until it is completed, essentially as in steps S3-S4. However, the determination that the instruction is conditional at S2 also starts a number of steps beginning at S6 to implement the conditional treatment concurrent with obtaining operand data.

At step S6, logic of one of the processing stages looks at the earlier instructions that are still in-flight in the pipeline, ahead of the present conditional instruction, to determine if any of those earlier instructions will set condition data. In the example, the register 23 holds the 4-bit ‘condition code’ (CC), and the logic determines whether or not one of the earlier in-flight instructions will rewrite the code value in the register 23. If a prior instruction will set the condition code in the register 23, then processing of the current conditional instruction will need to wait for that code to be set as indicated in step S7.

Assume now that the determination at S6 detects that a prior instruction will set the condition code in the register 23. In that case, processing moves to step S7, in which the logic determines if the earlier condition code update has been completed. If the condition code update is complete, processing moves to step S8 in which the condition is tested to determine if the instruction should be executed as defined or converted to a NOP.

At S6, the logic may determine that there is no earlier instruction still in-flight in the pipeline that will write the condition code to register 23. When the logic determines that no earlier instruction will set the condition code in the register 23, it is now possible to check the condition specified in the conditional instruction. Hence, the processing at S6 now moves to step S8.

At S8, the logic of the appropriate pipeline stage determines if the specified condition is met or not, based on examination of condition code in the CC register 23 and the requirements of the conditional instruction specified by the condition field. The condition field of the instruction refers to one, two or possibly more of the bits of the CC register in combination. For example, the field may specify an all-zero condition, essentially to check if a prior instruction set the Z bit to a 1. A positive number resulting from the previous operation to set the CC register 23 would be indicated by a 0 in the N bit (not negative) and a 0 in the Z bit (not all zeroes). So a conditional instruction based on a positive earlier result would check the N and Z bits to determine that they are both 0.

If the condition is met, then the instruction will execute in stages 37-41 of the pipeline 10. Hence, the full operand data is needed. In this case, the processing moves to step S3, to check if all of the operand data has been received or not. If all the operand data has been received, then the processing at S3 moves to step S5 in which the instruction and the operand data are passed to the appropriate stages for execution. If all the operand data has not yet been received for the current instruction, then the processing at S3 moves to S4 to cause the processor to wait for at least one processing cycle to receive all of the operands. When all the data operands have been received, processing moves from step S4 to step S5 in which the instruction and the operand data are passed to the appropriate stages for execution.

Now consider again the processing beginning at step S8. Upon first determining at S8 that the condition is not met (and can not be met as no older instruction will set the condition code), processing will move to step S9. The move to S9 terminates or bypasses processing through S3 and S4, which implemented the wait or stall until all operand data was received.

As noted earlier, there are several ways to resume passage of the conditional instruction through the pipeline, after the determination that the condition will result in no-execution of the instruction. In the example of FIG. 4, the instruction is marked or converted to a NOP (no-operation) instruction at step S9. The instruction goes to the Execute stages (at step S5), although those stages will simply pass the instruction without actual execution.

In the example, the pipeline logic at the EXE 1 stage 37 will determine if the condition is met or not based on examination of the condition code in the register 23 and the requirements of the conditional instruction specified by the condition field. If a prior instruction will set the condition code in the CC register 23, then this processing will wait for the code in that register to be set. Once the condition code is set, the logic will decide to not perform the conditional instruction or not based on the code. However, such processing need not wait for return of all of the operand data for the conditional instruction that will not execute.

In the example, the condition is checked at S8 during the EXE 1 stage 37. Alternatively, the condition could be checked as early as the Decode stage.

There may also be some circumstances where the condition is checked in later stages. For example, if the condition is met and all operand data accumulated in the Reg Read stage 15, the conditional instruction and data may pass to the Execute stages. One or more of the Execute stages may recheck the condition and then execute the instruction on the operand data, when it determines that the condition is met. As another example, if the stall is removed upon determination that the condition is not met, one approach marks the instruction as ‘all data received’ and passes the instruction to the Execute stages with whatever values appear in the EXE 1 stage 37 at the time. As the instruction passes through the Execute stages 37, 39 and 41, one or more of those stages will again recognize that the condition is not met and will prevent execution of the instruction.

While the foregoing has described what are considered to be the best mode and/or other examples, it is understood that various modifications may be made therein and that the subject matter disclosed herein may be implemented in various forms and examples, and that the teachings may be applied in numerous applications, only some of which have been described herein. It is intended by the following claims to claim any and all applications, modifications and variations that fall within the true scope of the present teachings.

What is claimed is:

1. A method of controlling processing of a conditional instruction through a pipeline processor comprising a plurality of processing stages, the method comprising:
decoding a conditional instruction in a first stage of the pipeline;
analyzing a condition required for executing the instruction to determine whether or not the instruction should be executed by a later stage of the pipeline; and
if the analysis of the condition indicates that the instruction should not be executed, skipping at least a portion of a period of waiting for operand data that otherwise would have been needed for execution of the conditional instruction.

2. The method of claim 1, wherein the step of skipping comprises passing the conditional instruction to the later stage of the pipeline, where it will not be executed, without waiting for completion of receiving of the operand data.

3. The method of claim 1, wherein the step of skipping comprises marking the conditional instruction as a no-operation (NOP) instruction, and passing the NOP instruction to the later stage of the pipeline

4. The method of claim 1, wherein the step of skipping comprises clearing the conditional instruction from the pipeline without passage to the later stage.

5. The method of claim 1, wherein:
the conditional instruction specifies a condition that is to be met if the instruction should be executed; and
the analyzing comprises comparing the specified condition to condition data written by an earlier instruction to determine if the condition is met.

6. The method of claim 5, wherein the analyzing step comprises:
determining whether or not any older instruction that has not yet been fully executed through the pipeline may set the condition required for executing the conditional instruction; and
performing the analyzing of the condition, when it is determined that no older instruction still being executed in the pipeline may set the condition.

7. The method of claim 6, further comprising:
commencing obtaining of operand data that otherwise would have been needed for execution of the conditional instruction and holding the conditional instruction from passage to the later stage to await completion of obtaining of the operand data, before it is determined that no older instruction being processed in a later stage of the pipeline may set the condition required for executing the conditional instruction; and
terminating the holding, when it is determined that no older instruction being processed in a later stage of the pipeline may set the condition required for executing the conditional instruction and the analyzing determines from the condition that the conditional instruction should be executed by a later stage of the pipeline.

8. The method of claim 1, wherein the conditional instruction comprises a condition field and a field containing an instruction to be executed based on the conditional analysis.

9. The method of claim 1, wherein the conditional instruction comprises:
a first instruction specifying a condition that is to be met; and
a second instruction specifying an operation to be executed in the event the condition specified in the first instruction is met.

10. A pipelined processor configured to implement the method of claim 1.

11. A method of processing instructions through a pipeline, comprising:
fetching the instructions from memory in a desired sequence;
as each instruction is fetched in sequence, decoding each instruction;
for each of a plurality of the decoded instructions, obtaining operand data required by the instructions; and
passing instructions to an execution section of the pipeline;
wherein, for a conditional one of the decoded instructions for which operand data would be obtained and for which the obtaining of operand data requires a plurality of processing cycles, the method further comprises:
(a) analyzing a condition required for executing the conditional instruction to determine whether or not the instruction should be executed by the execution section of the pipeline;
(b) if the analysis of the condition indicates that the conditional instruction should be executed on a current pass through the pipeline, completing receipt of the operand data required by the conditional instruction and processing the conditional instruction and required operand data through the execution stage of the pipeline; and
(c) if the analysis of the condition indicates that the conditional instruction should not be executed on the current pass through the pipeline, skipping at least one of the processing cycles required for obtaining of operand data with respect to the conditional instruction.

12. The method of claim 11, wherein:
obtaining of the operand data with respect to the conditional instruction involves holding of the conditional instruction until expiration of the plurality of processing cycles required for obtaining the operand data; and
the skipping of at least one of the processing cycles comprises stopping the holding with respect to the conditional instruction upon determination that the condition indicates that the conditional instruction should not be executed, prior to expiration of the plurality of processing cycles.

13. The method of claim 11, wherein the analyzing step comprises:
determining whether or not any older instruction that has not yet been fully executed through the pipeline may set the condition required for executing the conditional instruction; and
performing the analyzing of the condition, upon determining that no older instruction still being executed in the pipeline may set the condition.

14. The method of claim 11, wherein the step of skipping comprises passing the conditional instruction to the execution section of the pipeline, where it will not be executed, immediately upon determining that the conditional instruction should not be executed.

15. The method of claim 11, wherein the step of skipping comprises marking the conditional instruction as a no-operation (NOP) instruction, and passing the NOP instruction to the execution section of the pipeline

16. The method of claim 11, wherein the step of skipping comprises clearing the conditional instruction from the pipeline without passage to the execution section.

17. The method of claim 11, wherein the conditional instruction comprises a condition field and a field containing an instruction to be executed based on the conditional analysis.

18. The method of claim 11, wherein the conditional instruction comprises:
a first instruction specifying a condition that is to be met; and
a second instruction specifying an operation to be executed in the event the condition specified in the first instruction is met.

19. A pipelined processor configured to implement the method of claim 11.

20. A pipelined processor for processing instructions, the pipeline processor comprising:
a register read stage for obtaining operand data needed for execution by each of a plurality of processing instructions;
an execution stage for executing processing instructions on corresponding operand data;
means for holding each of the plurality of processing instructions in turn, prior to execution thereof by the execution stage, until completion of receiving of corresponding operand data; and
means for determining, prior to completion of a hold for receiving of corresponding operand data with respect to a conditional one of the processing instructions, whether or not the conditional instruction will be executed and terminating the hold with respect to the conditional execution upon determining that the conditional will not be executed.

21. The pipelined processor of claim 20, further comprising:
means for determining whether or not any older instruction that has not yet been fully executed through the pipeline processor may set a condition required for executing the conditional instruction,
wherein the determination of whether or not the conditional instruction will be executed is made upon determining that there is not any older instruction that has not yet been fully executed through the pipeline processor that may set the required condition.
